(19) United States
(12) Patent Application Publication
(10) Pub. No.: US 2008/0247840 A1
(43) Pub. Date: Oct. 9, 2008

(54) Fastener and Fastener Tightening/Loosening Device

(76) Inventor: Brian Davies, Esperance (AU)

Correspondence Address: BLANK ROME LLP, 600 NEW HAMPSHIRE AVENUE, N.W., WASHINGTON, DC, 20037, US

(21) Appl. No.: 11/996,949

(22) PCT Filed: Jul. 26, 2006
(86) PCT No.: PCT/AU2006/001049

§ 371 Date: Jun. 9, 2008

(30) Foreign Application Priority Data
Jul. 26, 2005 (AU) 2005903968

(51) Int. Cl. F16B 39/28; F16B 27/00; F16B 35/00

(52) U.S. Cl. 411/107; 411/383

(57) ABSTRACT

A fastener that includes a head part having an internally threaded hole extending from one side of the head part to another side of the head part, an externally threaded shank in threaded engagement with the internally threaded hole of the head part, the shank being externally threaded for threaded engagement with a nut, and an externally threaded locking part in threaded engagement with the internally threaded hole of the head part, wherein the shank and the locking part are in contact with each other inside the threaded hole, such that the locking part resists against travel of the shank through the threaded hole.

### FIELD OF THE INVENTION

The present invention relates to a fastener and a fastener tightening/loosening device.

### BACKGROUND OF THE INVENTION

Fasteners in the form of bolts are well known. A bolt can be formed of a threaded shank and an internally threaded head. In typical use, an internally threaded nut is screwed onto the shank to apply a clamping force between the nut and the head of the bolt. However, when the nut is to be tightened or loosened, there can be instances where rotation of the nut does not result in the nut rotating around the shank, but instead results in the shank rotating with the nut. This is because the shank is rotating in the head. An aspect of the present invention seeks to address this problem.

One type of bolt fastener has a round head with the threaded shank projecting from it. Unlike a traditional hexagonally shaped head, a round head is not able to be engaged by a typical turning device, such as a spanner or a wrench, in order to hold or rotate the bolt. Nor is a round head able to be engaged in a complementary hexagonally shaped recess in order to hold the head to prevent rotation of the bolt. Accordingly, these bolts rely on friction between the head and a clamped surface to stop the head from rotating during tightening/loosening of the nut.

It is not uncommon for the nut to seize on the shank after exposure to dust or the elements. If this occurs and the nut is to be removed, turning the nut often results in the round head slipping and thus the bolt rotating, rather than remaining stationary. In these circumstances, the nut cannot be removed normally. Instead the nut (or head of the bolt) is often cut away, which is undesirable. Also, sometimes during tightening, the nut does not rotate around the shank because the shank rotates with the nut. This can be due to the round head slipping because of insufficient fiction with the clamped surface. Another aspect of the present invention seeks to address these problems.

It is to be understood that, if any prior art publication is referred to herein, such reference does not constitute an admission that the publication forms a part of the common general knowledge in the art, in the United States or any other country.

### SUMMARY OF THE INVENTION

According to an aspect of the present invention there is provided a fastener that includes a head part having an internally threaded hole extending from one side of the head part to another side of the head part, an externally threaded shank in threaded engagement with the internally threaded hole of the head part, the externally threaded shank being externally threaded for threaded engagement with a nut, and an externally threaded locking part in threaded engagement with the internally threaded hole of the head part, wherein the externally threaded shank and the externally threaded locking part are in contact with each other inside the internally threaded hole of the head part such that the locking part resists against travel of the shank through the internally threaded hole of the head part.

According to another aspect of the present invention, there is provided a fastener that includes a head part having an internally threaded hole extending from one side of the head part to another side of the head part, an externally threaded shank arranged to engage with the internally threaded hole of the head part, the externally threaded shank being of a length so as to present external thread for threaded engagement by a nut when the externally threaded shank is wound into the head part, and an externally threaded locking part arranged to engage with the internally threaded hole of the head part, wherein, in use, the externally threaded shank and the externally threaded locking part are each wound into the head part so as to make contact with each other inside the internally threaded hole of the head part such that the externally threaded locking part resists against further travel of the shank through the internally threaded hole of the head part.

Additionally, the shank may include a first hole therein for receiving a holding/turning device when the externally threaded locking part is engaged with the head part; the externally threaded locking part may have a second hole therein for receiving a holding/turning device when the externally threaded locking part is engaged with the head part; a bonding agent may be disposed on the thread of the head part for bonding the head part to the shank and the externally threaded locking part; and/or the head part may have a hardness greater than the hardness of the externally threaded locking part.

According to another aspect of the present invention, there is provided a bolt that includes a head part and a shank projecting form the head part, the shank having a first hole in a longitudinal end thereof, the first hole being configured to receive a corresponding projection therein such that torque may transferred from the projection to the shank and from the shank to the projection.

Additionally, the head part may have a second hole axially aligned with the shank, the second hole being configured to receive a corresponding second projection therein such that torque may be transferred from the second projection to the head part and from the head part to the second projection; the head part may have a hardness greater than the hardness of the shank, such as, for example, at least 300 BH; the head part may have an external surface of frustoconical shape, the frustoconical shape narrowing toward the shank projecting from the head part; the narrowest part of the frustoconical shape may be larger than the diameter of the shank; the head part may have a planar surface substantially perpendicular to the length of the shank projecting from the head part; the first hole may be hexagonal in shape; and/or the second hole may be hexagonal in shape.

According to yet another aspect of the present invention, there is provided a fastener tightening/loosening device that includes a socket drive extending from the body, the socket drive being configured to engage a socket for turning a nut, and a shaft extending through the socket drive, the shaft being configured to engage a hole in a shank of a bolt such that when engaged with the shank torque is transferred between the shaft and the shank, wherein one of the socket drive and the shaft is configured to rotate relative to the body and the other is configured not to rotate relative to the body.

Additionally, the shaft may be movable through the socket drive in a direction towards the body; the shaft may be biased in a direction away from the body; the shaft may configured not to rotate relative to the body; the shaft may have a cross-section transverse to its length that is hexagonal in shape; and/or the body may have an immobile part with a hexagonal hole therethrough, the immobile part being configured so the shaft can travel longitudinally through the immobile part while restraining the shaft from rotating about its length.

According to another aspect of the present invention, there is provided a fastener tightening/loosening device that includes a body, a socket extending from the body, the socket suitable for engaging a nut, and a shaft extending through the socket, the shaft being configured to engage a hole in a shank of a bolt such that when engaged with the shank torque is transferred between the shaft and the shank, wherein one of the socket drive and the shaft is configured to rotate relative to the body and the other is configured not to rotate relative to the body.

### BRIEF DESCRIPTION OF THE DRAWINGS

In order to provide a better understanding of the present invention, preferred embodiments will now be described in greater detail, by way of example only, with reference to the accompanying drawings, in which:

FIG. 1 is a schematic partial cross-sectional view of an embodiment of a fastener according to one aspect of the present invention;

FIG. 2 is an end view of a shank taken from the left-hand side of FIG. 1;

FIG. 3 is an end view of a head and the shank taken from the right-hand side of FIG. 1;

FIG. 4 is a schematic side elevation of an embodiment of a fastener tightening/loosening device according to another aspect of the present invention; and

FIG. 5 is a close-up cross-sectional side view of part of the device of FIG. 4 in use.

### DETAILED DESCRIPTION OF EXEMPLARY EMBODIMENTS

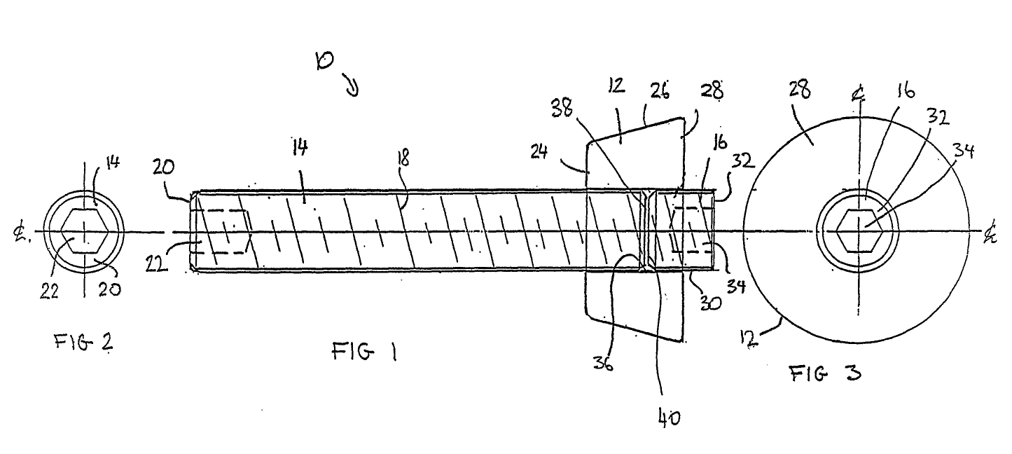

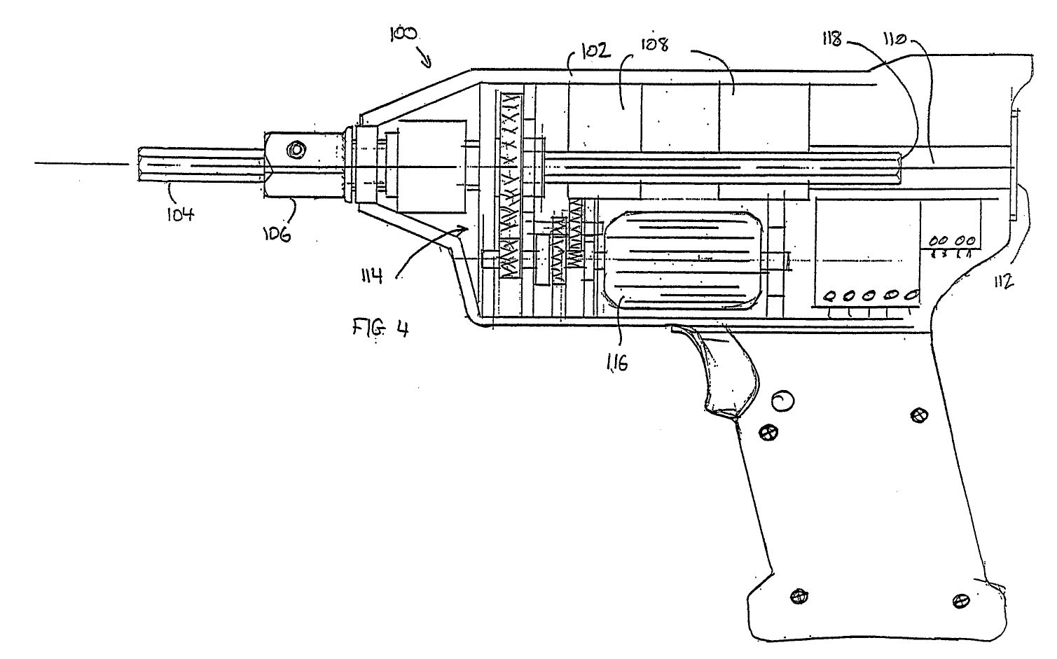

Referring to FIGS. 1-3, there is shown a fastener in the form of a bolt 10 comprised of a head 12, a shank 14, and a locking means 16. The shank 14 has opposed ends 20 and 38 and is provided with external thread 18. The external thread 18 need not be in the middle of the shank 14. The end 20 is remote from the head 12 and has an axially aligned hole 22 therein.

The head 12 has an internally threaded hole there through, with the thread represented by 36. The hole passes between opposed surfaces 24 and 28 of the head 12. The head 12 is shaped with a frustoconical external surface 26 disposed between the surfaces 24 and 28. Although, in this embodiment, the frustoconical shape is circular in perpendicular cross-section to its center, it need not necessarily be circular. The narrowest part of the frustoconical surface 26 has a diameter larger than the diameter of the internally threaded hole (and the diameter of the shank 14). The difference in the diameters between the frustoconical surface 26 and the internally threaded hole provides for annular surface 24, which is perpendicular to the length of the shank 14.

The locking means 16 has an external thread 30 similar to the external thread 18 of the shank 14. The locking means 16 has a first end 40 and a second end 32. An axially aligned hole 34 extends inwardly from the second end 32.

It can be seen that the shank 14 is screwed into the internally threaded hole of the head 12. It is desirable for the shank 14 to be at least half way through the head 12 so that sufficient threaded engagement is provided between the shank 14 and the head such that when the fastener 10 is used in a joint and tension is applied to the shank 14, the head 12 can be loaded so as to clamp the object being fastened (in order to form the joint) without there being a failure of the engagement between the shank 14 and the head 12.

The locking means 16 is screwed into the opposite end of the head 12 so that the end 40 of the locking means 16 makes contact with the end 38 of the shank 14. Once contact is made, further rotation of the shank 14 into the head 12 is prevented since attempted movement of the shank 14 into the head 12 pushes against the locking means 16 whereupon the thread 30 of the locking means 16 grips the internal thread 36 of the head 12 resisting this movement.

Typically, a bonding agent (not shown) is used to bond the inside surface of the hole through the head 12 to the locking means 16 and the shank 14, thereby further resisting movement of the shank 14 through the head 12 while also resisting removal of the shank 14 and the locking means 16 from the head 12. Preferably, the bonding agent is an anaerobic adhesive, such as a thread locker.

The fastener 10 can be used as the bolt system described in Australian Provisional Patent Application No. 2005901394, the disclosure of which are incorporated herein by reference.

It will be appreciated that by forming the bolt 10 of the head 12 and the threaded shank 14 in this manner, the head 12 can have different material properties to that of the shank 14. Typically, the shank 14 is formed of mild steel. However, the head 12 may be formed of a much harder material so as to be used to clamp, for example, a wear plate, which will typically have a high hardness to resist wear. Thus, in this non-limiting application, the head 12 will usually have a hardness the same as the hardness of the wear plate. Typically, this will be at least a hardness of 300 BH, more often at least 350 BH, with hardnesses also known to be of 400-700 BH.

The holes 22 and 34 are desirably hexagonal in shape so as to receive an Allen key or similar device.

Thus, to manufacture the bolt 10, the bonding adjacent is applied to the inside of the hole through the head 12 and/or to the end portions of the shank 14 and locking means 16 that will be located in the head 12. The locking means 16 can then be screwed into the head 12 to a desired depth using an Allen key and the shank 14 can likewise be screwed into the head 12 so as to contact the locking means 16, also using an Allen key or similar. The order of screwing these into the head 12 is not essential and may depend on the intended use of the fastener 10. The locking means 16 and shank 14 can be tightened by rotating the respective Allen keys in opposite directions, thereby locking the shank 14 in position within the head 12.

In use, the bolt 10 can be inserted within a correspondingly shaped recess of a part to be clamped, such as on the wearing side of a wear plate. On the other side of the wear plate and support structure, a nut (not shown) can then be screwed on to the threaded shank 14. Thus, when the nut is screwed onto the shank 14, the shank 14 is prevented from moving through the head 12 due to the locking means 16.

In a wear plate application, it is expected that the protruding portion of the locking means 16 will be quickly worn away and the remainder of the locking means 16 will be worn as the head 12 wears away.

It will be appreciated that the head need not be in the form illustrated. For example, it could be more flange-like with a flat or rounded end, or it could have a standard hexagonal shape.

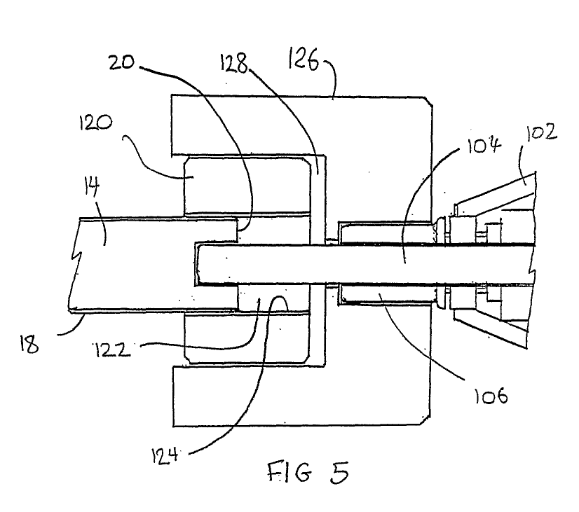

Referring to FIGS. 4 and 5, there is shown a tightening/loosening device 100 in the form of a hand-held tool gun, with a standard pistol grip. The device comprises a body 102, a socket drive 106 projecting from the body 102, and a shaft 104 extending co-axially through the socket drive 106 into the body 102.

The shaft 104 is linearly moveable through the socket drive and within the body 102. At least one brace 108, in this case two braces 108, are fixed to the body 102. Each brace 108 has a suitably shaped hole though which the shaft 104 can travel. The braces 108 restrict the shaft to linear movement and prevent the shaft 104 from rotating with respect to the body 102. Typically the shaft 104 is of a hexagonal shape in cross-section so as to operate in a similar manner to an Allen key. The holes of the braces 108 are also hexagonally shaped.

Preferably the internal end 118 of the shaft 104 is spaced from the rear of the body 102 so as to form a gap 110. It is desirable for a spring (not shown) to be placed within the gap 110 in contact with end 118 so as to allow the shaft 104 to retreat into the body 102, but also to urge the shaft 104 to return to its fully extended position. The rear of the body 102 may have a hatch 112 to allow access to the shaft 104 so that, should the shaft 104 become damaged, the shaft 104 can be removed and replaced. The spring can be fixed to the body 102 or to the hatch 112.

The socket drive 106 is connected to a motor 116 via gears 114 so that, upon power being applied to the motor 116, the socket drive 106 is rotated in relation to the body 102. The direction of rotation may be electrically controlled by operation of a suitable switch (not shown). Alternatively, the direction of rotation may be changed by selection of appropriate direction controlling gears. The motor 116 may also be hydraulic or pneumatic instead of electric. A housing of the motor 116 is fixed to the body 102.

Referring to FIG. 5, use of the device 100 is explained in more detail. A socket 126 is inserted over the socket drive 106. The socket 126 is the typical type used with a socket wrench and has an internal hexagonally shaped hole 128 for receiving a nut 120 of corresponding size. The shaft 104 passes through the socket 126 and may be inserted in the hole 22 in the end 20 of a shank 14 of a bolt, such as the bolt 10 described above. It is noted that the bolt 10 described above need not be used in this embodiment. It is merely necessary for the shank 14 of the bolt to have a suitably shaped hole in the end 20 thereof for the device 100 to be used as described in this non-limiting embodiment. The shank 14 and shaft 104 engage so that torque is transferred between them. In particular, if one is held stationary, the other will also be held stationary.

In this configuration, the nut 120 can be screwed on to the thread 18 of the shank 14 of the bolt 14 by powering the motor 116 so as to rotate the socket drive 106 and thus the socket 126, which in turn rotates the nut 120 relative to the shank 14. The shank 14 is held stationary by its engagement with the shaft 104, which in turn is held stationary relative to the body 102 of the tool 100. Thus, any torque which is applied by the nut 120 to the shank 14 is, in turn, transferred to the shaft 104 and then, in turn, to the body 102. Due to the housing of the motor 116 being fixed to the body 102, any force produced by the torque transferred from the shaft 104 counteracts the force applied to the body 102 that is produced by operation of the motor 102. If there is any resultant turning of the body 102, this can be resisted by the user of the tool 100. As the nut 120 is threaded onto the shank 14 (to tighten the nut 210), the end 20 will move closer to the socket drive 106. This is accommodated by the shaft 104 sliding through the socket drive 106 and braces 108. When the tool 100 is removed, the shaft 104 will return to its starting position under the motivation of the spring in the gap 110.

Similarly, if the nut 120 is difficult to remove from the shank 14, as is the case when the nut 120 has seized, the tool 100 can be used by inserting the shaft 104 into the hole 22 and, at the same time, positioning the socket 106 over the nut 120. This will typically involve pushing the tool 100 so as to move the shaft 104 further into the body 102. Upon application of power to the motor 106, the socket drive 106 will be rotated so as to rotate the socket 106, and thus the nut 120, in a direction to loosen the nut 120 from the shank 14. This is useful for preventing the shank 14 from rotating relative to the socket 126 and nut 120, particularly where a round bolt head is used, such as, for example, the bolt head of FIG. 1. Any torque applied by the nut 120 to the shank 14 is then, in turn, transferred to the shaft 104, which is then, in turn, transferred to the body 102. Accordingly, any force produced by the torque transferred from the shaft 104 to the body 102 counteracts the force applied to the body 102 that is produced by operation of the motor 102. Thus, the tool 100 can hold the bolt 14 still, preventing it from turning, while at the same time loosening the nut 120 so as to remove it from the bolt 14.

An advantage of having the locking means in the fastener is that the problem of the shank winding through the bolt head is overcome.

An advantage of having the hole in locking means is that it is easier to tighten the locking means against the bolt shank.

An advantage of having the hole in the free end of the shank is that it is easier to tighten the bolt shank against the locking means.

Another advantage of having the hole in the free end of the shank is that the shank may be held while winding the nut on or off the shank from the same side of the joint. Thus, there is no need to hold the bolt on both side of the joint, which is often inconvenient.

An advantage of the tightening/loosening tool is that a bolt with a hole in the free end of the shank can be easily held and at the same time the nut can be wound on or off the shank.

Modifications and variations may be made to present invention without departing from the basic inventive concept. Such modifications and variations may include the following.

The hole in the locking means is not essential in some embodiments. Alternatively the hole may be in another form such as a slot(s) for receiving a Flat screwdriver or a hole for a Phillips, Star or other form of screwdriver.

The hole in the end 20 of the shank need not be provided in the embodiment with the locking means. Alternatively it may be provided in an alternative form such as a slot(s) for receiving a Flat, Phillips, Star or other type of screwdriver.

The bolt may have the hole in the end 20 of the shank but the locking means need not be provided in some embodiments.

The socket drive of the tool may be replaced with a socket of the most convenient size.

The drive mechanism of the toot could be rearranged such that the shaft is rotated relative to the body but the socket drive remains stationary relative to the body. Such an arrangement would be useful where it is desirable to hold a nut in place, but the shaft is to be rotated. This may be useful where a threaded stud is used instead of a bolt.

Such modifications and variations are intended to fall within the scope of the present invention, the nature of which to be determined from the foregoing description.

Throughout this specification, except where the context requires otherwise due to express language or necessary implication, the words “comprise” or variations such as “comprises” or “comprising” are used in an inclusive sense, i.e., to specify the presence of the stated features but not to preclude the presence or addition of further features in various embodiments of the invention.

1. A fastener comprising:
a head part having an internally threaded hole extending from one side of the head part to another side of the head part;
an externally threaded shank in threaded engagement with the internally threaded hole of the head part, the shank being externally threaded for threaded engagement with a nut; and
an externally threaded locking part in threaded engagement with the internally threaded hole of the head part,
wherein the shank and the locking part are in contact with each other inside the threaded hole, such that the locking part resists against travel of the shank through the threaded hole.

2. A fastener according to claim 1, wherein the shank includes a first hole therein for receiving a holding/turning device when the locking part is engaged with the head part.

3. A fastener according to claim 2, wherein the locking part has a second hole therein for receiving a holding/turning device when the locking part is engaged with the head part.

4. A fastener according to claim 1, wherein a bonding agent is disposed on the thread of the head part for bonding the head part to the shank and the locking part.

5. A fastener according to claim 1, wherein the head part has a hardness greater than the hardness of the locking part.

6. A fastener system comprising:
a head part having an internally threaded hole extending from one side of the head part to another side of the head part;
an externally threaded shank arranged to engage with the internally threaded hole of the head part, the shank being of a length so as to present external thread for threaded engagement by a nut when the shank is wound into the head part; and,
an externally threaded locking part arranged to engage with the internally threaded hole of the head part,
wherein, in use, the shank and locking part are each wound into the head part so as to make contact with each other inside the threaded hole, such that the locking part resists against further travel of the shank through the threaded hole.

7. A bolt comprising:
a head part; and
a shank projecting from the head part, the shank having a first hole in a longitudinal end thereof, the first hole being configured to receive a corresponding projection therein such that torque is transferred from the projection to the shank and from the shank to the projection.

8. A bolt according to claim 7, wherein the head part has a second hole axially aligned with the shank, the second hole being configured to receive a corresponding second projection therein such that torque is transferred from the second projection to the head part and from the head part to the second projection.

9. A bolt according to claim 7, wherein the head part has a hardness greater than the hardness of the shank.

10. A bolt according to claim 7, wherein the hardness of the head part is at least 300 BH.

11. A bolt according to claim 7, wherein the head part has an external surface of frustoconical shape, the frustoconical shape narrowing toward the shank projecting from the head part.

12. A bolt according to claim 7, wherein the narrowest part of the frustoconical shape is larger than the diameter of the shank.

13. A bolt according to claim 12, wherein the head part has a planar surface substantially perpendicular to the length of the shank projecting from the head part.

14. A bolt according to claim 7, wherein the first hole is hexagonal in shape.

15. A bolt according to claim 7, wherein the second hole is hexagonal in shape.

16. A fastener tightening/loosening device comprising:
a body;
a socket drive extending from the body, the socket drive being configured to engage a socket for turning a nut; and
a shaft extending through the socket drive, the shaft being configured to engage a hole in a shank of a bolt such that when engaged with the shank torque is transferred between the shaft and the shank,
wherein one of the socket drive and the shaft is configured to rotate relative to the body and the other is configured not to rotate relative to the body.

17. A device according to claim 16, wherein the shaft is movable through the socket drive in a direction towards the body.

18. A device according to claim 16, wherein the shaft is biased in a direction away from the body.

19. A device according to claim 16, wherein the shaft is configured not to rotate relative to the body.

20. A device according to claim 16, wherein the shaft has a cross-section transverse to its length that is hexagonal in shape.

21. A device according to claim 20, wherein the body has an immobile part with a hexagonal hole therethrough, the immobile part being configured so the shaft can travel longitudinally through the immobile part while restraining the shaft from rotating about its length.

22. A fastener tightening/loosening device comprising:
a body;
a socket extending from the body, the socket suitable for engaging a nut; and
a shaft extending through the socket, the shaft being configured to engage a hole in a shank of a bolt such that when engaged with the shank torque is transferred between the shaft and the shank,
wherein one of the socket drive and the shaft is configured to rotate relative to the body and the other is configured not to rotate relative to the body.
